(19) United States
(12) Patent Application Publication
(10) Pub. No.: US 2026/0111014 A1
(43) Pub. Date: Apr. 23, 2026

(54) UNMANNED INTELLIGENT STAMPING SYSTEM AND STAMPING METHOD

(71) Applicant: Chi ZHANG, Guangzhou (CN)

(72) Inventors: Chi ZHANG, Guangzhou (CN); Sanyi ZHANG, Guangzhou (CN); Haibo CUI, Guangzhou (CN); Risheng ZHOU, Guangzhou (CN); Jinqing YUAN, Guangzhou (CN)

(21) Appl. No.: 19/403,355

(22) Filed: Nov. 28, 2025

Related U.S. Application Data
(63) Continuation of application No. PCT/CN2024/075889, filed on Feb. 5, 2024.

(30) Foreign Application Priority Data
Jun. 1, 2023 (CN) 2023106360226

(51) Int. Cl. G05B 19/418

(52) U.S. Cl. CPC G05B 19/4187; G05B 2219/32252

(57) ABSTRACT

The present invention provides an unmanned intelligent stamping method and a stamping system, relates to the technical field of stamping intelligent control. The method comprises: acquiring element data of stamping production, generating a stamping production plan according to the acquired element data, and correcting the production plan according to a production event in the stamping production process; and according to the corrected stamping production plan, sequentially performing full-process control of blank stock verification, blank inbound control, blank transportation control, die transportation control, end effector transportation and installation control, quality inspection control, packaging control, material basket transportation control, and part production control. Therefore, unmanned operation of the entire stamping production process is realized, the labor cost is reduced, the consistency of parts in stamping production is ensured, and automatic generation and self-adaptive modification of a stamping production plan are realized.

### CROSS-REFERENCE TO RELATED APPLICATIONS

The present invention claims priority to Chinese Patent Application No. 202310636022.6, filed with the China National Intellectual Property Administration on Jun. 1, 2023, entitled “UNMANNED INTELLIGENT STAMPING SYSTEM AND STAMPING METHOD”, the entire content of which is incorporated herein by reference and constitutes part of the present invention for all purposes.

### TECHNICAL FIELD

The present invention relates to the technical field of stamping intelligent control, and in particular to an unmanned intelligent stamping system and stamping method.

### BACKGROUND

The statements in this section merely provide background art related to the present invention and do not necessarily constitute the prior art.

Stamping plants (workshops) in traditional automobile factories are equipped with 1 to 3 or even more stamping production lines. Currently, automation in automobile manufacturing plants is only achieved for blank destacking, cleaning, oiling, centering, and stamping, while almost all other operations of the stamping lines are performed manually, including manual loading, manual die change, manual preparation of end effectors and tooling, manual quality inspection, manual packaging, and manual forklift transportation for warehousing, resulting in issues such as low production efficiency, high labor costs, and production safety hazards.

For example, in the traditional stamping production process, a large number of manual operations are involved: 1 production planning staff/production line/shift, 1 blank loading forklift operator/2 production lines/shift, 2 die hoisting and changing staff/production line/shift, 1 end effector and tooling preparation and changing staff/production line/shift, 1 production operator/production line/shift, 4-8 quality inspection staff/production line/shift, 4 packaging staff/production line/shift, 2 material basket preparation and changing staff/production line/shift, 2 material basket warehousing staff/production line/shift, and 2 shift leaders and backup staff/production line/shift.

Therefore, the existing stamping production process requires the coordination of manpower from various types of work, leading to significant waste of labor costs; moreover, the collaborative cooperation of multiple personnel from different types of work across shifts fails to ensure the consistency of part quality during the stamping production process. Meanwhile, the production plans in the existing stamping production process need to be manually processed, such as manual shift scheduling and manual verification of production line data, making it impossible to formulate production plans intelligently and modify production plans adaptively according to the status of the production lines.

### SUMMARY

To address the deficiencies of the prior art, the present invention provides an unmanned intelligent stamping system and stamping method, through which fully unmanned operation throughout the stamping production process is achieved, reducing labor costs and ensuring part consistency in the stamping production; and meanwhile, automatic generation and adaptive modification of the stamping production plan are achieved, further improving the intelligence level of stamping production.

To achieve the above objectives, the present invention adopts the following technical solutions:

A first aspect of the present invention provides an unmanned intelligent stamping method.

An unmanned intelligent stamping method, including a process of:
acquiring various element data of stamping production, generating a stamping production plan according to the acquired various element data, and revising the production plan according to a production event in a stamping production process; and
sequentially performing full-process control of blank in-stock verification, blank inbound control, blank transportation control, die transportation control, end effector transportation and installation control, quality inspection control, packaging control, material basket transportation control, and part production control according to a revised stamping production plan.

As a further limitation of the first aspect of the present invention, the various element data of the stamping production includes: order demand data, production process data, resource constraint data, procedure constraint data, calendar data, and rule data.

As a still further limitation of the first aspect of the present invention, the order demand data includes: sales order data, sales forecast data, planned order data, and production order data;
the production process data includes: process route data, lead working hour data, processing working hour data, and production efficiency data;
the resource constraint data includes: machine quantity and status data, die quantity and status data, personnel quantity and on-duty data, and material inventory data;
the procedure constraint data includes: an inter-procedure product batch transfer quantity, procedure interval time data, and qualification rate data;
the calendar data includes: a machine calendar, a shift, and working time; and
the rule data includes: an order rule, an equipment rule, an optimization rule, and a merging rule.

As a still further limitation of the first aspect of the present invention, the production plan includes: an order delivery date forecast, a daily delivery plan, a daily production plan, a shift production plan, a machine production line plan, and a material preparation and procurement plan.

As a still further limitation of the first aspect of the present invention, the production event in the stamping production process includes: one or more of equipment failure, die failure, a material inventory quantity, a month change, a season change, a climate change, a personnel physical condition change, and a demand change.

As a still further limitation of the first aspect of the present invention, the revised production plan is obtained according to the production event in the stamping production process and a preset neural network model; or the revised production plan is obtained according to the production event in the stamping production process and a pre-stored big data analysis result.

A second aspect of the present invention provides an unmanned intelligent stamping system.

An unmanned intelligent stamping system, including: a control terminal communicatively connected to controllers respectively corresponding to a blank stereoscopic warehouse, a virtual finished part stereoscopic warehouse, a decoiling and blanking line, a stamping line, an automatic hoisting device, an end effector stereoscopic warehouse, an automatic quality inspection system, a full-part automatic packaging system, and an unmanned handling device;
the control terminal is configured to: acquire various element data of stamping production, generate a stamping production plan according to the acquired various element data, and revise the production plan according to a production event in a stamping production process; and
sequentially perform full-process management and control of blank in-stock verification, blank inbound control, blank transportation control, die transportation control, end effector transportation and installation control, quality inspection control, packaging control, material basket transportation control, and part production control according to the revised stamping production plan.

As a further limitation of the second aspect of the present invention, performing the blank in-stock verification includes:
determining a required blank quantity according to order production information and a finished part quantity in the virtual finished part stereoscopic warehouse, verifying whether an in-stock blank quantity in the blank stereoscopic warehouse is sufficient, and if the in-stock blank quantity is not sufficient, generating a blank replenishment prompt or a blank replenishment instruction.

As a further limitation of the second aspect of the present invention, the blank inbound control includes:
when a material type is a blank, generating a blank warehousing instruction and sending the blank warehousing instruction to the controllers corresponding to the blank stereoscopic warehouse and the unmanned handling device; and when the material type is a coil material, generating a decoiling and blanking instruction according to a required blank quantity and sending the decoiling and blanking instruction to the controller corresponding to the decoiling and blanking line, and after receiving a completion notification of decoiling and blanking, sending a blank warehousing instruction to the controllers corresponding to the blank stereoscopic warehouse and the unmanned handling device.

As a further limitation of the second aspect of the present invention, the blank transportation control includes:
notifying the blank stereoscopic warehouse of a required blank type according to the stamping production plan, so that the blank stereoscopic warehouse transports a blank to an outlet, and notifying the unmanned handling device to transport the blank from a specified outlet to a loading position of the stamping line according to transportation completion feedback information from the blank stereoscopic warehouse.

As a further limitation of the second aspect of the present invention, the die transportation control includes:
sending a die transportation control instruction to the automatic hoisting device according to the stamping production plan, so that the automatic hoisting device hoists a corresponding die to a workbench of the stamping line according to the instruction.

As a further limitation of the second aspect of the present invention, the end effector transportation and installation control includes:
sending an instruction for preparing a corresponding end effector and corresponding tooling to the controller corresponding to the end effector stereoscopic warehouse and receiving warehouse outlet information sent by the controller corresponding to the end effector stereoscopic warehouse according to the stamping production plan; and
sending an end effector transportation and installation instruction to the controller corresponding to the unmanned handling device according to the information fed back by the end effector stereoscopic warehouse, so that the unmanned handling device takes the end effector from a warehouse outlet of the end effector stereoscopic warehouse and replaces the end effector on the corresponding tooling according to the instruction, and receiving end effector installation completion information sent by the controller corresponding to the unmanned handling device.

As a further limitation of the second aspect of the present invention, the material basket transportation control includes:
sending a data acquisition instruction to the controller corresponding to the finished part stereoscopic warehouse, and acquiring an empty material basket storage location and finished part storage location sent by the controller corresponding to the finished part stereoscopic warehouse according to the stamping production plan; and
sending a material basket transportation instruction to the controller corresponding to the unmanned handling device according to information from the finished part stereoscopic warehouse and the full-part automatic packaging system, so that the unmanned handling device places an empty material basket in the finished part stereoscopic warehouse on a corresponding station of the full-part automatic packaging system according to the instruction, and receiving material basket transportation completion information fed back by the unmanned handling device.

As a further limitation of the second aspect of the present invention, the part production control includes:
acquiring material shortage information fed back by the controller corresponding to the stamping line, and sending a blank supply instruction to the controllers corresponding to the blank stereoscopic warehouse and the unmanned handling device based on the material shortage information;
acquiring quality information fed back by the automatic quality inspection system; and when the full-part automatic packaging system fills a material basket, acquiring material basket full information, and sending a transportation instruction to the unmanned handling device, so that the unmanned handling device delivers a full material basket to the finished part stereoscopic warehouse and transports an empty material basket from the finished part stereoscopic warehouse to a corresponding station of the full-part automatic packaging system.

A third aspect of the present invention provides an unmanned intelligent stamping method.

An unmanned intelligent stamping method, including a process of:
determining a required blank quantity according to order production information and a finished part quantity in a virtual finished part stereoscopic warehouse, communicating with a controller corresponding to a blank stereoscopic warehouse to verify whether an in-stock blank quantity is sufficient, and if the in-stock blank quantity is not sufficient, generating a blank replenishment prompt or a blank replenishment instruction by a control terminal;
if an incoming material is a blank, communicating with the controller corresponding to the blank stereoscopic warehouse to specify a warehousing location, and communicating with a controller corresponding to an unmanned handling device and issuing an instruction by the control terminal, delivering, by the unmanned handling device, the blank to a designated inlet of the blank stereoscopic warehouse according to the instruction, and transporting, by the blank stereoscopic warehouse, the blank to a designated storage location; and if the incoming material is a coil material, communicating with an automatic hoisting device and sending an instruction by the control terminal, and placing, by the automatic hoisting device, the coil material into a designated storage location of a decoiling and blanking line according to the instruction;
communicating with a controller corresponding to the decoiling and blanking line according to the required blank quantity and issuing an instruction by the control terminal, performing decoiling and blanking of the coil material according to the instruction and notifying the control terminal after the blanking is completed by the decoiling and blanking line, communicating, by the control terminal, with the controllers corresponding to the blank stereoscopic warehouse and the unmanned handling device according to blanking completion information, delivering, by the unmanned handling device, a blank to the designated inlet of the blank stereoscopic warehouse according to an instruction, and transporting, by the blank stereoscopic warehouse, the blank to the designated storage location;
notifying, by the control terminal, the controller corresponding to the blank stereoscopic warehouse of a required blank type according to the stamping production plan, transporting the blank to an outlet according to information and notifying the control terminal by the blank stereoscopic warehouse, and notifying, by the control terminal, the unmanned handling device to transport the blank from a specified outlet to a loading position of a stamping line according to information from the blank stereoscopic warehouse;
sending, by the control terminal, a die hoisting instruction to an automatic hoisting device according to the stamping production plan, and hoisting, by the automatic hoisting device, a corresponding die to a workbench of the stamping line according to the die hoisting instruction;
notifying, by the control terminal, a controller corresponding to an end effector stereoscopic warehouse to prepare a corresponding end effector and corresponding tooling according to the stamping production plan, and feeding back a warehouse outlet to the control terminal;
notifying, by the control terminal, the controller corresponding to the unmanned handling device according to information fed back by the end effector stereoscopic warehouse, and taking the end effector from the warehouse outlet of the end effector stereoscopic warehouse according to information and replacing the end effector on the corresponding tooling, and timely feeding back information to the control terminal by the unmanned handling device;
sending, by the control terminal, a quality inspection instruction to an automatic quality inspection system according to the stamping production plan, and performing quality inspection control according to the quality inspection instruction and feeding back a quality inspection result to the control terminal by the automatic quality inspection system;
notifying, by the control terminal, a full-part automatic packaging system according to the stamping production plan, and adjusting a belt conveyor position and switching a strategy according to information and feeding back to the control terminal by the full-part automatic packaging system;
notifying, by the control terminal, a finished part stereoscopic warehouse according to the stamping production plan, and feeding back, by the finished part stereoscopic warehouse, an empty material basket storage location and a finished part storage location to the control terminal according to information;
notifying, by the control terminal, the unmanned handling device according to information from the finished part stereoscopic warehouse and the full-part automatic packaging system, and placing an empty material basket in the finished part stereoscopic warehouse on a corresponding station of the full-part automatic packaging system according to information and feeding back to the control terminal by the unmanned handling device; and starting, by the control terminal, production after all mechanisms are ready according to information fed back by each component.

As an optional implementation, in the production process, after the blank loaded on the stamping line is used up, the controller corresponding to the stamping line communicates with the control terminal, and the control terminal notifies the blank stereoscopic warehouse and the unmanned handling device to replenish a blank according to production information;
in the production process, the automatic quality inspection system inspects part quality, communicates with the full-part automatic packaging system to inform the full-part automatic packaging system of quality information, and communicates with the control terminal to inform the control terminal of the quality information;
in the production process, after filling a material basket, the full-part automatic packaging system communicates with the control terminal, and the control terminal notifies the unmanned handling device to deliver a full material basket to the finished part stereoscopic warehouse and transport the empty material basket from the finished part stereoscopic warehouse to the corresponding station of the full-part automatic packaging system according to material basket full information;
in the production process, the control terminal interacts in real time with the controllers corresponding to the blank stereoscopic warehouse, the virtual finished part stereoscopic warehouse, the decoiling and blanking line, the stamping line, the automatic hoisting device, the end effector stereoscopic warehouse, the automatic quality inspection system, the full-part automatic packaging system, and the unmanned handling device, monitors a production situation, and determines whether it is necessary to stop a line for die inspection and maintenance and equipment maintenance according to feedback information from each controller;
in the production process, the control terminal displays or reports the production information to a control end corresponding to staff in real time; and in the production process, the control terminal communicates with each controller to start preparation work for a next set of production parts.

Compared with the prior art, the beneficial effects of the present invention are as follows:
1. According to the unmanned intelligent stamping system and stamping method of the present invention, full-process unmanned control operations including blank in-stock verification, blank inbound control, blank transportation control, die transportation control, end effector transportation and installation control, quality inspection control, packaging control, material basket transportation control, and part production control are achieved, which reduces labor costs and ensures part consistency in the stamping production, and improves the stamping quality of parts.
2. According to the unmanned intelligent stamping system and stamping method of the present invention, unmanned operation is achieved for the work of production planning and blank management personnel, the work of die hoisting and replacement personnel, end effector and tooling preparation and replacement, quality inspection of finished parts, the work of finished part packaging personnel, material basket preparation and replacement, and material basket warehousing.
3. According to the unmanned intelligent stamping system and stamping method of the present invention, the ERP system acquires various element data of stamping production, generates a stamping production plan according to the acquired various element data, revises the production plan according to a production event in a stamping production process, and send the stamping production plan to the control terminal in real time or at regular intervals, which achieves the automatic generation and adaptive modification of the stamping production plan and further improves the intelligence level of stamping production.

The advantages of the additional aspects in the present invention will be partially given in the following description, and part of them will become obvious from the following description or be understood through the practice of the present invention.

### BRIEF DESCRIPTION OF THE DRAWINGS

The specification drawings that form part of the present invention are used to provide a further understanding of the present invention, and the schematic embodiments of the present invention and their descriptions are used to explain the present invention, and do not constitute an improper limitation of the present invention.

FIG. 1 is a schematic structural diagram of an unmanned intelligent stamping system provided in Embodiment 1 of the present invention; and

FIG. 2 is a schematic layout diagram of an unmanned intelligent stamping system provided in Embodiment 1 of the present invention.

In the figures, 1—blank stereoscopic warehouse; 2—unmanned forklift (for blank transferring); 3—stamping line; 4—automatic quality inspection system; 5—full-part automatic packaging system; 6—unmanned forklift (for material basket transferring); 7—material basket warehouse; 8—decoiling and blanking line; and 9—coil material storage location.

### DETAILED DESCRIPTION

The present invention will be further described below in conjunction with the accompanying drawings and embodiments.

In a case of no conflict, the embodiments of the present invention and features in the embodiments can be combined with each other.

### Example 1

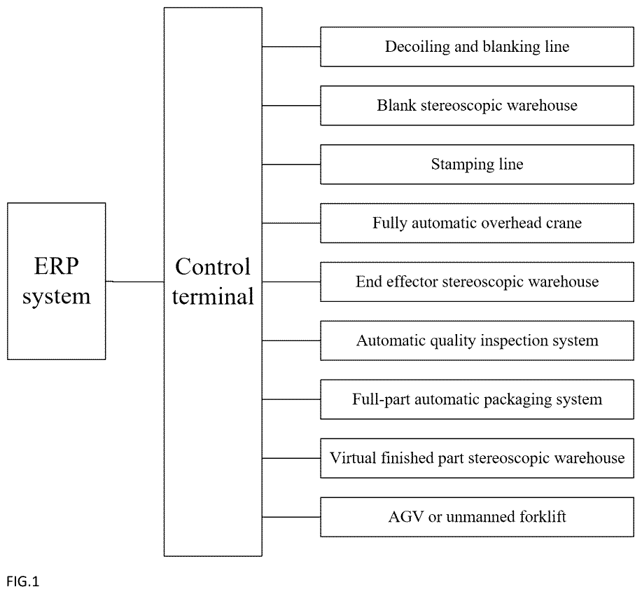

As shown in FIG. 1, the Example 1 of the present invention provides an unmanned intelligent stamping system, including: a control terminal communicatively connected to controllers respectively corresponding to a blank stereoscopic warehouse, a virtual finished part stereoscopic warehouse, a decoiling and blanking line, a stamping line, an automatic hoisting device, an end effector stereoscopic warehouse, an automatic quality inspection system, a full-part automatic packaging system, and an unmanned handling device, where the control terminal is communicatively connected to an Enterprise Resource Planning (ERP) system;
the ERP system is configured to: acquire various element data of stamping production, generate a stamping production plan according to the acquired various element data, revise the production plan according to a production event in a stamping production process, and send the stamping production plan to the control terminal in real time or at regular intervals; and
the control terminal is configured to: perform full-process control of blank in-stock verification, blank inbound control, blank transportation control, die transportation control, end effector transportation and installation control, quality inspection control, packaging control, material basket transportation control, and part production control according to the stamping production plan.

In the present example, the various element data of the stamping production includes: order demand data, production process data, resource constraint data, procedure constraint data, calendar data, and rule data;

It can be understood that, in some other implementations, external influence data or internal influence data may also be included, where examples of external influence data include power supply data, water resource supply data, and the like, and examples of internal influence data include temporary worker scheduling data, temporary production suspension data caused by an internal reason, and the like.

In the present example, the order demand data includes: sales order data, sales forecast data, planned order data, and production order data. It can be understood that in some other implementations, temporary order data and the like may also be included.

The production process data includes: process route data, lead working hour data, processing working hour data, and production efficiency data. It can be understood that in some other implementations, material data required for processes, material replenishment time data for each process, and the like may also be included.

The resource constraint data includes: machine quantity and status data, die quantity and status data, personnel quantity and on-duty data, and material inventory data; the procedure constraint data includes: an inter-procedure product batch transfer quantity, procedure interval time data, and qualification rate data; the calendar data includes: a machine calendar, a shift, and working time; and the rule data includes: an order rule, an equipment rule, an optimization rule, and a merging rule.

The production plan includes: an order delivery date forecast, a daily delivery plan, a daily production plan, a shift production plan, a machine production line plan, and a material preparation and procurement plan.

In the present example, the production event in the stamping production process includes: one or more of equipment failure, die failure, a material inventory quantity, and a demand change.

In the present example, during the first use, data within a set time period (for example, one year) is collected and analyzed to obtain a change situation of an equipment failure rate, a die failure rate, or the material inventory quantity as well as a situation of the demand change, and the production plan is adjusted according to a situation obtained through big data analysis;

It can be understood that after the first adjustment based on historical data, analysis is continuously conducted according to real-time collected data, and adaptive adjustment of the production plan is performed according to time-varying data to achieve a balance between a low cost and a high profit (here, plan setting can be performed with a goal of a minimum cost, or with a goal of a maximum profit, or balanced control of the two can be implemented).

In the present example, the ERP system is further configured to: generate cost data according to the acquired various element data, where the cost data includes: cost forecast data, planned total cost data, equipment cost data, material cost data, personnel cost data, and tooling and die cost data.

In the present example, the production event may further include stamping plans for products in different months, different seasons, or different sets. Therefore, automatic revision of production plans may also be performed according to different production seasons, different production months (lunar months, where staff reduction situations vary in different months, and raw material supply or sales situations also vary in different months), or different stamping plans (e.g., stamping complete sets of products, where each set of products includes multiple parts, and designation of one stamping plan generally requires completing stamping of each part in a complete set of products), or the like. The above different production seasons, months, or stamping plans can be automatically generated for each specific situation of different production seasons, months, or stamping plans by means of big data analysis.

In the present example, market data (including a market sales situation, raw material supply information, or relevant policy information) is analyzed in real time or at regular intervals according to big data, and adaptive production order revision or early warning is performed according to the acquired data.

In the present example, for a product that shows a good sales situation (or a relatively good future prospect) through big data analysis, the stamping product materials corresponding to this product are prioritized for arrangement, that is, set at a priority production level, and materials for other products are arranged in sequence according to their importance levels or market sales situations of the products.

It is understandable that in some other implementations, the ERP system may be further configured to: generate an order Gantt chart, a procedure Gantt chart, a machine Gantt chart, load and shortage data, and abnormal early warning data according to the acquired various element data.

In the present example, the blank stereoscopic warehouse, the virtual finished part stereoscopic warehouse, the decoiling and blanking line, the stamping line, the automatic hoisting device, the end effector stereoscopic warehouse, the automatic quality inspection system, the full-part automatic packaging system, and the unmanned handling device are all equipped with their respective controllers, which are configured to implement their respective data collection, data reception, data transmission, and action control. Specific controllers may be the ones built into each warehouse, and communicate with the control terminal through a unified protocol interface.

Specific respective functions of each functional entity are existing solutions in the art and are not regarded as innovative content of this solution. For example, the following patents can fully realize the operation of the above systems: (1) Chinese Patent Application Number: CN201620059004.1, entitled “AUTOMATIC AGV DOLLY COMMODITY CIRCULATION CONVEYING SYSTEM THAT CASES IN PUNCHING PRESS LINE END”; (2) Chinese Patent Application Number: CN201820253101.3, entitled “STEREOSCOPIC STORAGE DEVICE FOR END EFFECTOR;” CN201510337966.9, entitled “SYSTEM AND METHOD FOR AUTOMATICALLY PACKING ALL PARTS AT END OF STAMPING LINE”; and, Chinese Patent Application Number: CN201911228175.7 “VIRTUAL STEREOSCOPIC STORAGE SYSTEM AND METHOD.”

In the present example, a blank refers to a material that has not been formed by stamping; a coil material refers to a steel plate in a coil form, which needs to be decoiled and blanked to form a blank; a finished part refers to a part formed by stamping, which may be used in a subsequent welding procedure; a material basket refers to a container used for storing multiple finished parts; and full parts refer to all types of finished parts.

An end effector refers to a gripper for grabbing parts.

In the present example, the control terminal is a host computer control terminal, and may also be remotely deployed in the form of cloud services. Those skilled in the art may make a selection according to specific working conditions, which will not be repeated here.

In the present example, structures of the blank stereoscopic warehouse, the virtual finished part stereoscopic warehouse, the decoiling and blanking line, the stamping line, the automatic hoisting device, the end effector stereoscopic warehouse, the automatic quality inspection system, the full-part automatic packaging system, and the unmanned handling device themselves may all adopt existing automation solutions, that is, existing automatic blank management systems, existing decoiling and blanking lines, existing quality inspection systems, and the like. Those skilled in the art may select from the prior art according to specific working conditions, as long as they can achieve the fully automated full-process stamping control described in the present example, which will not be repeated here.

In the present example, the automatic hoisting device may be a fully automatic overhead crane or a fully automatic wireless die change vehicle. Those skilled in the art may make a selection according to specific working conditions, which will not be repeated here.

In the present example, the unmanned handling device may be an unmanned forklift or an automated guided vehicle (AGV). Those skilled in the art may make a selection according to specific working conditions, which will not be repeated here.

In the present example, the solution is for a single production line. A stamping plant may have two or more stamping lines, which may be implemented by increasing the number of control terminals. For a stamping plant with two or more stamping lines, there may be only one blank stereoscopic warehouse or one finished part stereoscopic warehouse. In this case, multiple control terminals may be configured in a master-slave setup or an independent host computer setup. Those skilled in the art may make a selection according to specific working conditions, which will not be repeated here.

In the present example, performing the blank in-stock verification includes:
determining a required blank quantity according to order production information and a finished part quantity in the virtual finished part stereoscopic warehouse, verifying whether an in-stock blank quantity in the blank stereoscopic warehouse is sufficient, and if the in-stock blank quantity is not sufficient, generating a blank replenishment prompt or a blank replenishment instruction.

In the present example, the blank inbound control includes:
when a material type is a blank, generating a blank warehousing instruction and sending the blank warehousing instruction to the controllers corresponding to the blank stereoscopic warehouse and the unmanned handling device; and when the material type is a coil material, generating a decoiling and blanking instruction according to a required blank quantity and sending the decoiling and blanking instruction to the controller corresponding to the decoiling and blanking line, and after receiving a completion notification of decoiling and blanking, sending a blank warehousing instruction to the controllers corresponding to the blank stereoscopic warehouse and the unmanned handling device.

In the present example, the blank transportation control includes:
notifying the blank stereoscopic warehouse of a required blank type according to the stamping production plan, so that the blank stereoscopic warehouse transports a blank to an outlet, and notifying the unmanned handling device to transport the blank from a specified outlet to a loading position of the stamping line according to transportation completion feedback information from the blank stereoscopic warehouse.

In the present example, the die transportation control includes:
sending a die transportation control instruction to the automatic hoisting device according to the stamping production plan, so that the automatic hoisting device hoists a corresponding die to a workbench of the stamping line according to the instruction.

In the present example, the end effector transportation and installation control includes:
sending an instruction for preparing a corresponding end effector and corresponding tooling to the controller corresponding to the end effector stereoscopic warehouse and receiving warehouse outlet information sent by the controller corresponding to the end effector stereoscopic warehouse according to the stamping production plan; and
sending an end effector transportation and installation instruction to the controller corresponding to the unmanned handling device according to the information fed back by the end effector stereoscopic warehouse, so that the unmanned handling device takes the end effector from a warehouse outlet of the end effector stereoscopic warehouse and replaces the end effector on the corresponding tooling according to the instruction, and receiving end effector installation completion information sent by the controller corresponding to the unmanned handling device.

In the present example, the material basket transportation control includes:
sending a data acquisition instruction to the controller corresponding to the finished part stereoscopic warehouse, and acquiring an empty material basket storage location and finished part storage location sent by the controller corresponding to the finished part stereoscopic warehouse according to the stamping production plan; and
sending a material basket transportation instruction to the controller corresponding to the unmanned handling device according to information from the finished part stereoscopic warehouse and the full-part automatic packaging system, so that the unmanned handling device places an empty material basket in the finished part stereoscopic warehouse on a corresponding station of the full-part automatic packaging system according to the instruction, and receiving material basket transportation completion information fed back by the unmanned handling device.

In the present example, the part production control includes:
acquiring material shortage information fed back by the controller corresponding to the stamping line, and sending a blank supply instruction to the controllers corresponding to the blank stereoscopic warehouse and the unmanned handling device based on the material shortage information;
acquiring quality information fed back by the automatic quality inspection system; and when the full-part automatic packaging system fills a material basket, acquiring material basket full information, and sending a transportation instruction to the unmanned handling device, so that the unmanned handling device delivers a full material basket to the finished part stereoscopic warehouse and transports an empty material basket from the finished part stereoscopic warehouse to a corresponding station of the full-part automatic packaging system.

In the present example, the quality inspection control includes:
notifying the controller corresponding to the automatic quality inspection system according to the stamping production plan, so that the automatic quality inspection system switches to a corresponding strategy according to information, and acquiring, by the control terminal, a quality inspection result feedback sent by the controller corresponding to the automatic quality inspection system.

In the present example, the packaging control includes:
notifying the full-part automatic packaging system according to the stamping production plan, so that the full-part automatic packaging system adjusts a belt conveyor position and switches a strategy according to information, and acquiring, by the control terminal, a packaging completion instruction sent by the full-part automatic packaging system.

In the present example, the part production control further includes:
in the production process, interacting, by the control terminal, with each controller in real time to monitor a production situation, and determining whether it is necessary to stop a line for die inspection and maintenance and equipment maintenance according to feedback information from each mechanism;
in the production process, displaying or reporting, by the control terminal, the production information to a control end corresponding to staff (i.e., a mobile control terminal or computer terminal equipment corresponding to plant management personnel) in real time; and In the production process, the control terminal communicates with each controller and starts preparation work for a next set of production parts.

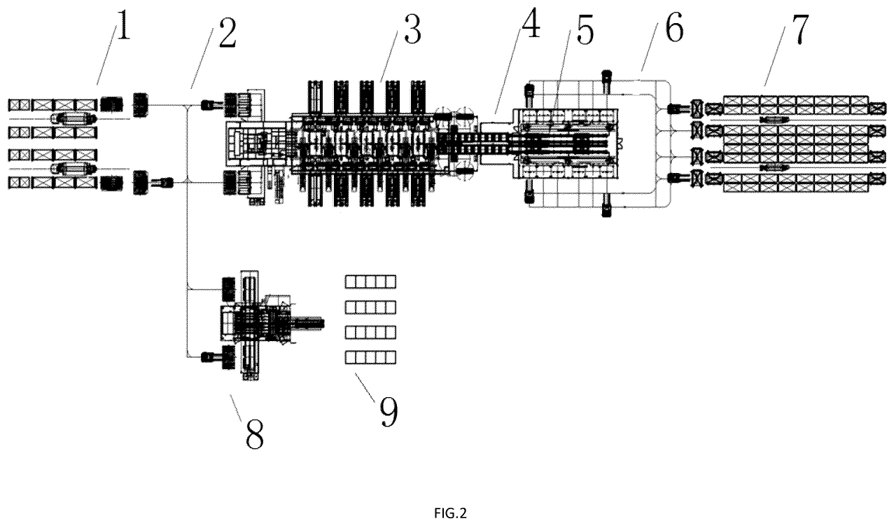

More specifically, as shown in FIG. 2, an overall layout of the stamping system may include: a blank stereoscopic warehouse 1, an unmanned forklift (for blank transfer) 2, a stamping line 3, an automatic quality inspection system 4, a full-part automatic packaging system 5, an unmanned forklift (for material basket transfer) 6, a material basket warehouse 7, a decoiling and blanking line 8, and a coil material storage location 9.

### Example 2

The Example 2 of the present invention provides an unmanned intelligent stamping method, including the following process:
S1: A control terminal determines a required blank quantity according to order production information and a finished part quantity in a virtual finished part stereoscopic warehouse, communicates with a blank stereoscopic warehouse to verify whether an in-stock blank quantity is sufficient, and if the in-stock blank quantity is not sufficient, generates a blank replenishment prompt or a blank replenishment instruction to prompt stamping plant management personnel to prepare a material.
S2: The material in the stamping plant is generally divided into a coil material and a blank, and after the material is delivered to the stamping plant, the stamping plant management personnel inputs material information into the control terminal.

According to the material information, if the material is a blank, the control terminal communicates with the blank stereoscopic warehouse to designate a warehousing location, and communicates with an unmanned forklift to issue an instruction, the unmanned forklift delivers the blank to a designated inlet of the blank stereoscopic warehouse according to the instruction, and the blank stereoscopic warehouse transports the blank to a designated storage location; and if the material is a coil material, the control terminal communicates with a fully automatic overhead crane, and the fully automatic overhead crane places the coil material into a designated storage location of a decoiling and blanking line according to the instruction.
S3: The control terminal communicates with the decoiling and blanking line according to the required blank quantity and issues an instruction, and the decoiling and blanking line performs decoiling and blanking of the coil material according to the instruction. After the blanking is completed, the decoiling and blanking line notifies the control terminal, the control terminal communicates with the blank stereoscopic warehouse and the unmanned forklift according to blanking completion information, the unmanned forklift delivers a blank to the designated inlet of the blank stereoscopic warehouse according to an instruction, and the blank stereoscopic warehouse transports the blank to the designated storage location.
S4 The control terminal notifies the blank stereoscopic warehouse of a required blank type according to the stamping production plan, and the blank stereoscopic warehouse transports the blank to an outlet according to information and notifies the control terminal; and the control terminal notifies the unmanned forklift to transport the blank from a specified outlet to a loading position of a stamping line according to information from the blank stereoscopic warehouse.
S5 The control terminal notifies the fully automatic overhead crane according to the stamping production plan, where the fully automatic overhead crane lifts a corresponding die to a workbench of the stamping line according to information.
S6 The control terminal notifies an end effector stereoscopic warehouse to prepare a corresponding end effector and corresponding tooling according to the stamping production plan, and a warehouse outlet is fed back to the control terminal.
S7 The control terminal notifies an AGV according to information fed back by the end effector stereoscopic warehouse, and the AGV takes the end effector from the warehouse outlet of the end effector stereoscopic warehouse according to information and replaces the end effector on the corresponding tooling, and timely feeds back information to the control terminal.
S8 The control terminal notifies an automatic quality inspection system according to the stamping production plan, where the automatic quality inspection system switches to a corresponding program according to information and feeds back to the control terminal.
S9 The control terminal notifies a full-part automatic packaging system according to the stamping production plan, and the full-part automatic packaging system adjusts a belt conveyor position and switches a program according to information and feeds back to the control terminal.
S10 The control terminal notifies a finished part stereoscopic warehouse according to the stamping production plan, and the finished part stereoscopic warehouse feeds back an empty material basket storage location and a finished part storage location to the control terminal according to information.
S11 The control terminal notifies the unmanned forklift according to information from the finished part stereoscopic warehouse and the full-part automatic packaging system, and the unmanned forklift places an empty material basket in the finished part stereoscopic warehouse on a corresponding station of the full-part automatic packaging system according to information and feeds back to the control terminal.
S12 The control terminal starts production after all mechanisms are ready according to information fed back by each component.
S13 In the production process, after the blank loaded on the stamping line is used up, the stamping line communicates with the control terminal, and the control terminal notifies the blank stereoscopic warehouse and the unmanned forklift to replenish a blank according to the production information (repeat S4).
S14 In the production process, the automatic quality inspection system inspects part quality, and communicates with the full-part automatic packaging system to inform the full-part automatic packaging system of quality information; and the automatic quality inspection system communicates with the control terminal to inform a host computer system of the quality information.
S15 In the production process, after filling a material basket, the full-part automatic packaging system communicates with the control terminal, and the control terminal notifies the unmanned forklift to deliver a full material basket to the finished part stereoscopic warehouse and transport the empty material basket from the finished part stereoscopic warehouse to the corresponding station of the full-part automatic packaging system according to the blanking completion information (repeat S11).
S16 In the production process, the control terminal interacts with each mechanism in real time to monitor a production situation, and determines whether it is necessary to stop a line for die inspection and maintenance, equipment maintenance, and the like according to feedback information from each mechanism.

Specifically, if the automatic quality inspection system detects a batch of defective parts (a quantity of defective parts in a batch can be set), it is necessary to stop a line for die inspection and maintenance at this time; and for a signal such as a temperature, a pressure, and a current in feedback information from each controller, a warning range is set, and if the signal remains within the warning range for a long time, equipment maintenance is required.
S17 In the production process, the control terminal displays or reports the production information in real time to a control end corresponding to the plant management personnel (i.e., a mobile control terminal or computer terminal equipment corresponding to the plant management personnel).
S18 In the production process, the control terminal communicates with each mechanism and starts preparation work for a next set of production parts. Examples of the preparation work include blank preparation, die change preparation, end effector change preparation, material basket change preparation, and the like.

1. An unmanned intelligent stamping method, comprising a process of:
acquiring various element data of stamping production, generating a stamping production plan according to the acquired various element data, and revising the production plan according to a production event in a stamping production process;
wherein the various element data of the stamping production comprises: order demand data, production process data, resource constraint data, procedure constraint data, calendar data, and rule data; wherein the calendar data comprises: a machine calendar, a shift, and working time; and the production event in the stamping production process comprises: one or more of equipment failure, die failure, a material inventory quantity, a month change, a season change, a climate change, a personnel physical condition change, and a demand change;
when the production plan is revised according to the production event in the stamping production process for the first time, data within a set time period is collected for analysis to obtain a change situation of an equipment failure rate, a die failure rate, or the material inventory quantity as well as a situation of the demand change, and the production plan is adjusted according to a situation obtained through big data analysis; and
after the first adjustment, analysis is continuously performed according to real-time collected data, and adaptive adjustment of the production plan is performed according to time-varying data to achieve a balance between a low cost and a high profit; and
sequentially performing full-process control of blank in-stock verification, blank inbound control, blank transportation control, die transportation control, end effector transportation and installation control, quality inspection control, packaging control, material basket transportation control, and part production control according to a revised stamping production plan;
wherein the order demand data comprises: sales order data, sales forecast data, planned order data, and production order data;
the production process data comprises: process route data, lead working hour data, processing working hour data, and production efficiency data;
the resource constraint data comprises: machine quantity and status data, die quantity and status data, personnel quantity and on-duty data, and material inventory data;
the procedure constraint data comprises: an inter-procedure product batch transfer quantity, procedure interval time data, and qualification rate data;
the rule data comprises: an order rule, an equipment rule, an optimization rule, and a merging rule; and
the production plan comprises: an order delivery date forecast, a daily delivery plan, a daily production plan, a shift production plan, a machine production line plan, and a material preparation and procurement plan; and
the revised production plan is obtained according to the production event in the stamping production process and a preset neural network model; or the revised production plan is obtained according to the production event in the stamping production process and a pre-stored big data analysis result.

2. An unmanned intelligent stamping system, comprising:
a control terminal communicatively connected to controllers respectively corresponding to a blank stereoscopic warehouse, a virtual finished part stereoscopic warehouse, a decoiling and blanking line, a stamping line, an automatic hoisting device, an end effector stereoscopic warehouse, an automatic quality inspection system, a full-part automatic packaging system, and an unmanned handling device;
wherein the control terminal communicates with an ERP system, and the ERP system is configured to: execute the unmanned intelligent stamping according to claim 1 to revise a production plan, and send a revised stamping production plan to the control terminal in real time or at regular intervals; and
the control terminal is configured to: sequentially perform full-process control of blank in-stock verification, blank inbound control, blank transportation control, die transportation control, end effector transportation and installation control, quality inspection control, packaging control, material basket transportation control, and part production control according to the revised stamping production plan.

3. The unmanned intelligent stamping system according to claim 2, wherein performing the blank in-stock verification comprises:
determining a required blank quantity according to order production information and a finished part quantity in the virtual finished part stereoscopic warehouse, verifying whether an in-stock blank quantity in the blank stereoscopic warehouse is sufficient, and if the in-stock blank quantity is not sufficient, generating a blank replenishment prompt or a blank replenishment instruction.

4. The unmanned intelligent stamping system according to claim 2, wherein the blank inbound control comprises:
when a material type is a blank, generating a blank warehousing instruction and sending the blank warehousing instruction to the controllers corresponding to the blank stereoscopic warehouse and the unmanned handling device; and when the material type is a coil material, generating a decoiling and blanking instruction according to a required blank quantity and sending the decoiling and blanking instruction to the controller corresponding to the decoiling and blanking line, and after receiving a completion notification of decoiling and blanking, sending a blank warehousing instruction to the controllers corresponding to the blank stereoscopic warehouse and the unmanned handling device.

5. The unmanned intelligent stamping system according to claim 2, wherein the blank transportation control comprises:
notifying the blank stereoscopic warehouse of a required blank type according to the stamping production plan, so that the blank stereoscopic warehouse transports a blank to an outlet, and notifying the unmanned handling device to transport the blank from a specified outlet to a loading position of the stamping line according to transportation completion feedback information from the blank stereoscopic warehouse.

6. The unmanned intelligent stamping system according to claim 2, wherein the die transportation control comprises:
sending a die transportation control instruction to the automatic hoisting device according to the stamping production plan, so that the automatic hoisting device hoists a corresponding die to a workbench of the stamping line according to the instruction.

7. The unmanned intelligent stamping system according to claim 2, wherein the end effector transportation and installation control comprises:
sending an instruction for preparing a corresponding end effector and corresponding tooling to the controller corresponding to the end effector stereoscopic warehouse and receiving warehouse outlet information sent by the controller corresponding to the end effector stereoscopic warehouse according to the stamping production plan; and
sending an end effector transportation and installation instruction to the controller corresponding to the unmanned handling device according to the information fed back by the end effector stereoscopic warehouse, so that the unmanned handling device takes the end effector from a warehouse outlet of the end effector stereoscopic warehouse and replaces the end effector on the corresponding tooling according to the instruction, and receiving end effector installation completion information sent by the controller corresponding to the unmanned handling device.

8. The unmanned intelligent stamping system according to claim 2, wherein the material basket transportation control comprises:
sending a data acquisition instruction to the controller corresponding to the finished part stereoscopic warehouse, and acquiring an empty material basket storage location and finished part storage location sent by the controller corresponding to the finished part stereoscopic warehouse according to the stamping production plan; and
sending a material basket transportation instruction to the controller corresponding to the unmanned handling device according to information from the finished part stereoscopic warehouse and the full-part automatic packaging system, so that the unmanned handling device places an empty material basket in the finished part stereoscopic warehouse on a corresponding station of the full-part automatic packaging system according to the instruction, and receiving material basket transportation completion information fed back by the unmanned handling device.

9. The unmanned intelligent stamping system according to claim 2, wherein the part production control comprises:
acquiring material shortage information fed back by the controller corresponding to the stamping line, and sending a blank supply instruction to the controllers corresponding to the blank stereoscopic warehouse and the unmanned handling device based on the material shortage information;
acquiring quality information fed back by the automatic quality inspection system; and
when the full-part automatic packaging system fills a material basket, acquiring material basket full information, and sending a transportation instruction to the unmanned handling device, so that the unmanned handling device delivers a full material basket to the finished part stereoscopic warehouse and transports an empty material basket from the finished part stereoscopic warehouse to a corresponding station of the full-part automatic packaging system.

10. An unmanned intelligent stamping method, comprising a process of:
determining a required blank quantity according to a stamping production plan and a finished part quantity in a virtual finished part stereoscopic warehouse, communicating with a controller corresponding to a blank stereoscopic warehouse to verify whether an in-stock blank quantity is sufficient, and if the in-stock blank quantity is not sufficient, generating a blank replenishment prompt or a blank replenishment instruction by a control terminal; wherein the production plan is generated according to various element data of stamping production and revised according to a production event in a stamping production process;
if an incoming material is a blank, communicating with the controller corresponding to the blank stereoscopic warehouse to specify a warehousing location, and communicating with a controller corresponding to an unmanned handling device and issuing an instruction by the control terminal, delivering, by the unmanned handling device, the blank to a designated inlet of the blank stereoscopic warehouse according to the instruction, and transporting, by the blank stereoscopic warehouse, the blank to a designated storage location; and if the incoming material is a coil material, communicating with an automatic hoisting device and sending an instruction by the control terminal, and placing, by the automatic hoisting device, the coil material into a designated storage location of a decoiling and blanking line according to the instruction;
communicating with a controller corresponding to the decoiling and blanking line according to the required blank quantity and issuing an instruction by the control terminal, performing decoiling and blanking of the coil material according to the instruction and notifying the control terminal after the blanking is completed by the decoiling and blanking line, communicating, by the control terminal, with the controllers corresponding to the blank stereoscopic warehouse and the unmanned handling device according to blanking completion information, delivering, by the unmanned handling device, a blank to the designated inlet of the blank stereoscopic warehouse according to an instruction, and transporting, by the blank stereoscopic warehouse, the blank to the designated storage location;
notifying, by the control terminal, the controller corresponding to the blank stereoscopic warehouse of a required blank type according to the stamping production plan, transporting the blank to an outlet according to information and notifying the control terminal by the blank stereoscopic warehouse, and notifying, by the control terminal, the unmanned handling device to transport the blank from a specified outlet to a loading position of a stamping line according to information from the blank stereoscopic warehouse;
sending, by the control terminal, a die hoisting instruction to an automatic hoisting device according to the stamping production plan, and hoisting, by the automatic hoisting device, a corresponding die to a workbench of the stamping line according to the die hoisting instruction;
notifying, by the control terminal, a controller corresponding to an end effector stereoscopic warehouse to prepare a corresponding end effector and corresponding tooling according to the stamping production plan, and feeding back a warehouse outlet to the control terminal;
notifying, by the control terminal, the controller corresponding to the unmanned handling device according to information fed back by the end effector stereoscopic warehouse, and taking the end effector from the warehouse outlet of the end effector stereoscopic warehouse according to information and replacing the end effector on the corresponding tooling, and timely feeding back information to the control terminal by the unmanned handling device;
sending, by the control terminal, a quality inspection instruction to an automatic quality inspection system according to the stamping production plan, and performing quality inspection control according to the quality inspection instruction and feeding back a quality inspection result to the control terminal by the automatic quality inspection system;
notifying, by the control terminal, a full-part automatic packaging system according to the stamping production plan, and adjusting a belt conveyor position and switching a strategy according to information and feeding back to the control terminal by the full-part automatic packaging system;
notifying, by the control terminal, a finished part stereoscopic warehouse according to the stamping production plan, and feeding back, by the finished part stereoscopic warehouse, an empty material basket storage location and a finished part storage location to the control terminal according to information;
notifying, by the control terminal, the unmanned handling device according to information from the finished part stereoscopic warehouse and the full-part automatic packaging system, and placing an empty material basket in the finished part stereoscopic warehouse on a corresponding station of the full-part automatic packaging system according to information and feeding back to the control terminal by the unmanned handling device; and
starting, by the control terminal, production after all mechanisms are ready according to information fed back by each component;
wherein in the production process, after the blank loaded on the stamping line is used up, the controller corresponding to the stamping line communicates with the control terminal, and the control terminal notifies the blank stereoscopic warehouse and the unmanned handling device to replenish a blank according to production information;
in the production process, the automatic quality inspection system inspects part quality, communicates with the full-part automatic packaging system to inform the full-part automatic packaging system of quality information, and communicates with the control terminal to inform the control terminal of the quality information;
in the production process, after filling a material basket, the full-part automatic packaging system communicates with the control terminal, and the control terminal notifies the unmanned handling device to deliver a full material basket to the finished part stereoscopic warehouse and transport the empty material basket from the finished part stereoscopic warehouse to the corresponding station of the full-part automatic packaging system according to material basket full information;
in the production process, the control terminal interacts in real time with the controllers corresponding to the blank stereoscopic warehouse, the virtual finished part stereoscopic warehouse, the decoiling and blanking line, the stamping line, the automatic hoisting device, the end effector stereoscopic warehouse, the automatic quality inspection system, the full-part automatic packaging system, and the unmanned handling device, monitors a production situation, and determines whether it is necessary to stop a line for die inspection and maintenance and equipment maintenance according to feedback information from each controller;
in the production process, the control terminal displays or reports the production information to a control end corresponding to staff in real time; and
in the production process, the control terminal communicates with each controller to start preparation work for a next set of production parts.
